(19) United States
(12) Patent Application Publication
(10) Pub. No.: US 2016/0378086 A1
(43) Pub. Date: Dec. 29, 2016

(54) Control System Used for Precision Agriculture and Method of Use

(71) Applicants: Clayton L. Plymill, Lakeland, TN (US); Brett S. Norman, Memphis, TN (US)

(72) Inventors: Clayton L. Plymill, Lakeland, TN (US); Brett S. Norman, Memphis, TN (US)

(21) Appl. No.: 15/236,431

(22) PCT Filed: Mar. 28, 2015
(86) PCT No.: PCT/US2015/018209

§ 371 Date: Aug. 13, 2016

Related U.S. Application Data
(60) Provisional application No. 61/946,706, filed on Feb. 28, 2014.

(51) Int. Cl. G05B 19/042; A01G 25/16; H04W 4/02

(52) U.S. Cl. CPC G05B 19/0428; H04W 4/02; A01G 25/16; H04W 84/18

(57) ABSTRACT

This technology relates generally to control systems and, more particularly, to mobile control systems that facilitate security and maintenance of assets.

### FIELD

This technology relates generally to control systems and, more particularly, to mobile control systems used to detect and address in real time the cultivation needs of agriculture.

### BACKGROUND

It has been known for some time that different portions of a field have differing cultivation (e.g., watering, fertilizing, etc.) needs, however, the ability to remotely address those needs in real-time has been a very difficult undertaking. Attempts have been made to utilize sensors attached to the boom arms of a tractor or the central pivot itself as a means of checking environmental conditions as the boom arm passes over an area of interest. However, this method does not allow for constant sampling of soil and crop conditions. There is a need for a control system that includes in-ground field nodes that can continuously or intermittently collect soil, crop and ambient environmental conditions data, including atmospheric data, and remotely relay these data in addition to controlling the administration of relevant cultivation techniques to generate conditions in line with a benchmark standard. This automated process can be optimized by cognitive computing at the field node as a result of algorithms that take advantage of the historical information by collected by a population of field nodes. When multiple field nodes are deployed in an synchronized fashion, the environmental condition of an entire field can be assessed and managed without the risks of superfluous cultivation that could lead to crop damage. Additionally, harnessing the potential of a global network of field nodes comprising sensors could lead to very specific parameters for discrete portions of a field. These field nodes may also comprise global positioning and gyroscopic features that would allow the field nodes to be remotely monitored to ensure such field nodes remain where they were installed, further confirming the fidelity of the data. Additional features may include motion detection and avoidance capability to reduce the likelihood of damage by field machinery.

### DESCRIPTION OF THE FIGURES

FIG. 1 is a perspective view of a central pivot irrigation system including a boom arm assembly.

FIG. 2 is an aerial view of an exemplary field cultivated by a central pivot irrigation system.

FIG. 3 is a perspective view of a boom arm assembly of a central pivot irrigation system.

FIG. 4 is a plan view of multiple fields, as shown in FIG. 2, forming a potential large data set for a control system in accordance with an exemplary embodiment of a machine-learning and control system disclosed herein.

FIG. 5 is a perspective view of the components of the control system including the flow of information between the components, according to one example embodiment.

FIG. 6 is a perspective view of a field node according to one example embodiment.

### DETAILED DESCRIPTION

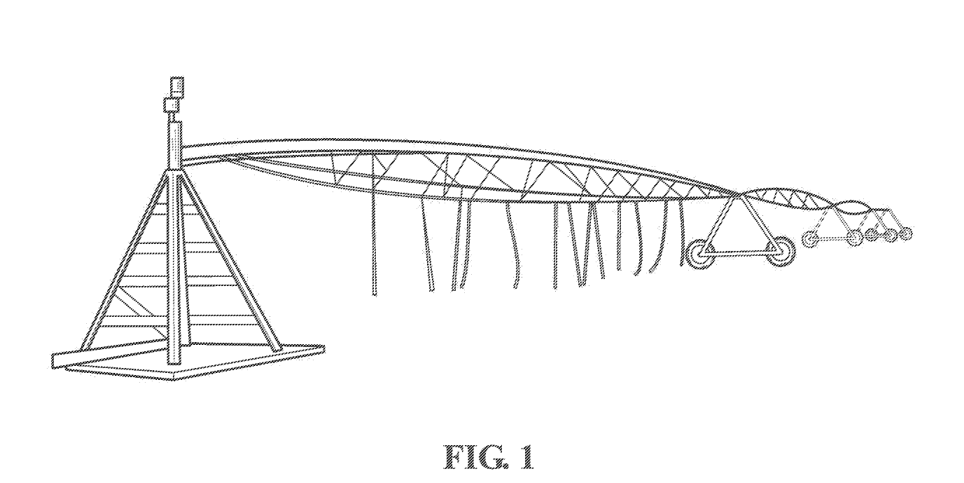

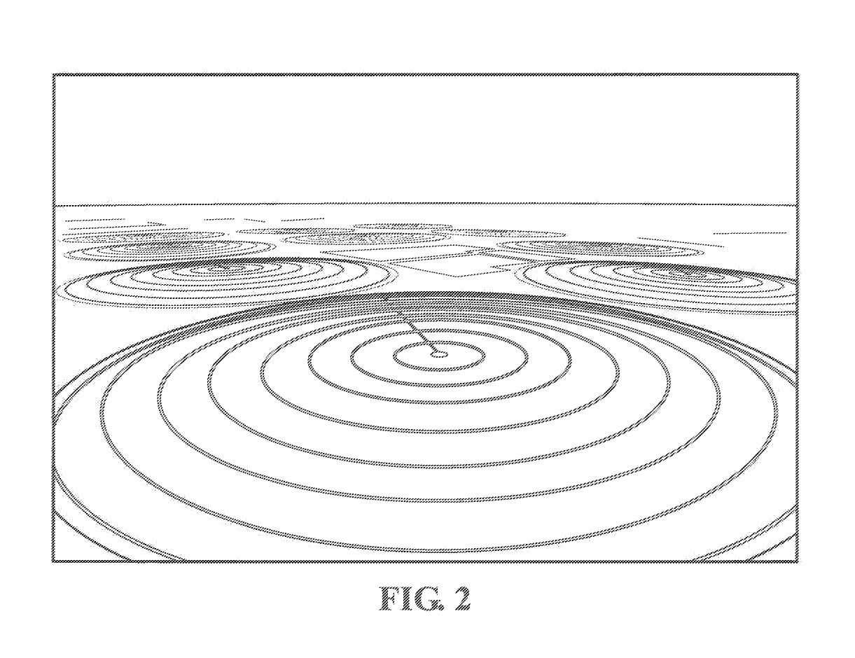

Soil properties, crop moisture demand and climatic variability all play a critical role in crop yield. Referring to FIGS. 1-6, a control system is provided that allows for the use of a plurality of field nodes 100 strategically placed throughout a target field (such as field shown in FIG. 2) in order to adequately cover differing portions of the field so as to provide statistically significant samples of soil properties in the field. The field nodes 100 are capable of logging relevant soil property data such as temperature, pH, moisture level, microorganism colonization, crop residue levels, organic chemical levels, etc. By gathering this data within specific fields and cataloging it in such a way that it can be compared to similar data in different fields, the information can be used to enhance uniform soil productivity by varying the agronomic treatment of different regions in a field.

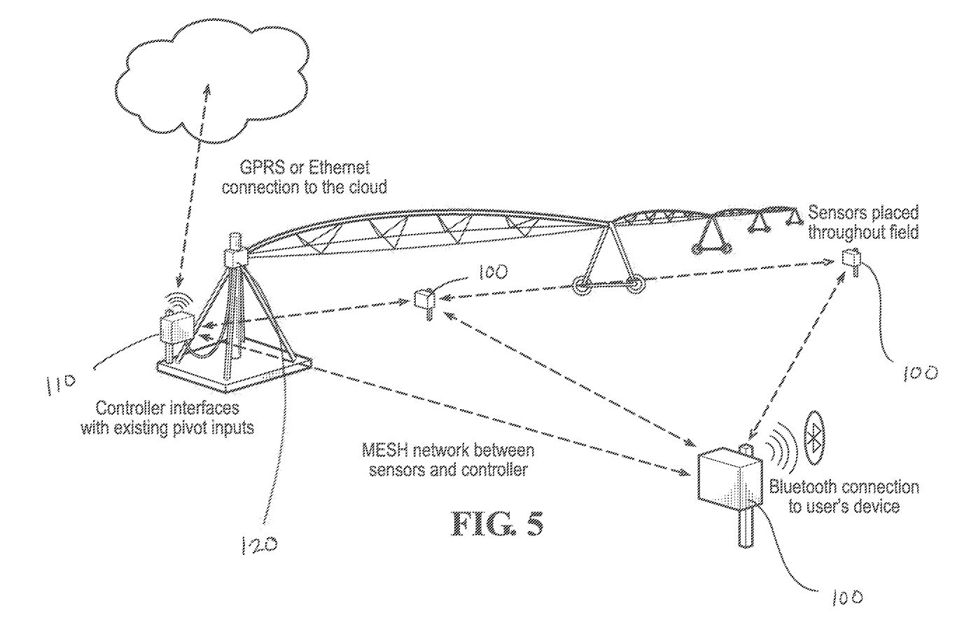

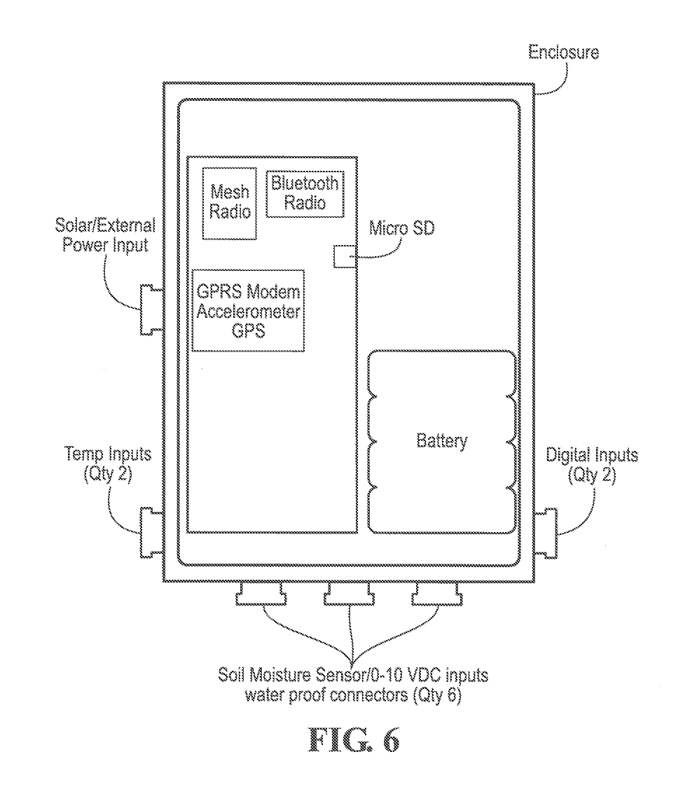

Referring to FIGS. 5 and 6, in one embodiment, each field node 100 may comprise a microprocessor having a plurality of inputs and outputs including six soil moisture sensors inputs and two temperature sensor inputs. In one embodiment, field node 100 comprises a 72 MHz, 32 bit ARM microprocessor with 1 MB Flash and 96 KB RAM. Each field node 100 may be equipped with a Zigbee radio with RPSMA antenna connector that wirelessly communicates its data and status to the autonomous pivot controller 110. In one embodiment, each field node 100 is configured to log data, report its location and make analytical decisions to self-calibrate, report malfunctions and conserve battery power. In another embodiment, field node 100 may comprise a Micro SD socket, 2 GB Card; six analog inputs supporting soil moisture sensors; two 10K T3 analog inputs, two digital inputs optically isolated, six analog outputs supporting 4-20 mA and 0-10V; and four relay digital outputs. In a further embodiment, field node 100 may be battery powered. Field node 100 may be designed to operate at least one year on a single battery.

The information gathered by the field nodes 100 will be transmitted back to the controller 110 via a mesh network and the information may be further transmittedwirelessly into the cloud, via a GPRS or Ethernet connection, where the information will be housed in a database (memory) that will be able to receive soil information in real-time.

Pivot controller 110 is capable of autonomous operation of an irrigation pivot. Algorithms constantly interpret real-time field conditions and compare them to locally stored and cloud-based matching historical irrigation performance accompanied with hyper-local weather data to optimize the time and duration of irrigation events. In one embodiment, controller 110 may notify products of imminent irrigation events and allow for manual override if necessary. If not overridden, the pivot controller may optimally irrigate to the configured crop specifications. Pivot controller 110 logs all field node data and irrigation data and pushes such data to the cloud layer.

In one embodiment, controller 110 comprises a microprocessor. In one embodiment, controller 100 comprises a 72 MHz, 32 bit ARM microprocessor with 1 MB Flash and 96 KB RAM. Controller 110 may be equipped with a Zigbee radio with RPSMA antenna connector that wirelessly receives communication from one or more field nodes 100 regarding data and status of field nodes 100. Controller 110 may also comprise a micro SD socket, 2GB card; an Ethernet Wi-Fi with RPSMA antenna connector; two analog inputs supporting 4-20 mA, 0-10 V and 10K T3, four digital inputs optically isolated; 6 analog outputs supporting 4-20 mA and 0-10 V; and three relay digital outputs and 1 triac digital output.

In addition to soil specific information, the field nodes 100 will be able to transmit ambient condition data collected at and/or above the surface so as to ensure that the conditions of the soil are documented in the context of the environmental conditions in which the soil and crops growing therein are being nurtured. For example, the soil in one part of the field may be sampled during a thunder or wind storm and such atmospheric data, in conjunction with the soil properties, may be used to compare, over time, the same field location under different atmospheric conditions to see how these environmental conditions affect the soil properties.

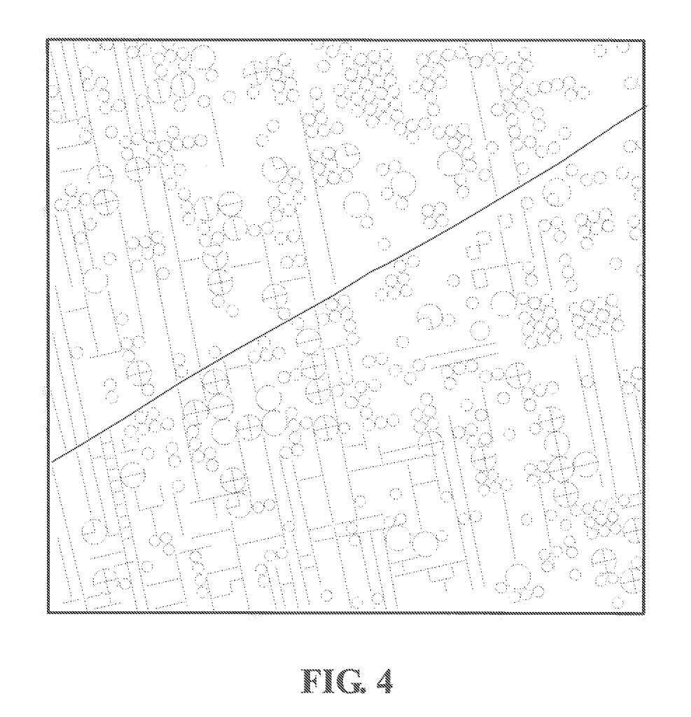

As the number of field nodes 100 in existing fields, as shown in FIG. 4, the algorithm used in the control system will be able to make correlations between soil conditions, other environmental and/or atmospheric conditions and crop type and therefrom either make recommendations to producers to make adjustments or automatically send signals to, for example, automated pivots 120 to begin irrigation, aeration, fertilization or pest control application. Essentially, the control system is able to learn from and use the data that is gathered from the field nodes 100. By using a system such as Google BigQuery, the discrete data points transmitted from each field node 100 through the controller 120 to the cloud can be run through a myriad of algorithms resulting in analytics that can be shared with predetermined users or configured to transmit command information to the automated pivot 120.

Most irrigation systems or monitoring systems, such as soil monitors, do not adapt to the environmental changes such as season, soil type or crop type; rather, the crop is forced to adapt to the static data preprogramed into platform, leading to reduced yield. Typically, customization of the platform is not possible. Because of the size of some fields, see FIG. 2, customization within a field is often necessary.

A “machine-learning service” or machine-learning and adaptation service can support automatic adaptation of preferences of finite portions of a larger field using the analytical tools applied to the large quantities of data, arriving at customized treatment protocols for field locations that will vary seasonally and generally over time. The machine-learning service is software running on a mobile platform that provides the necessary functionality for software applications to learn from interactions with the sensor data concerning soil properties, environmental conditions and crop properties.

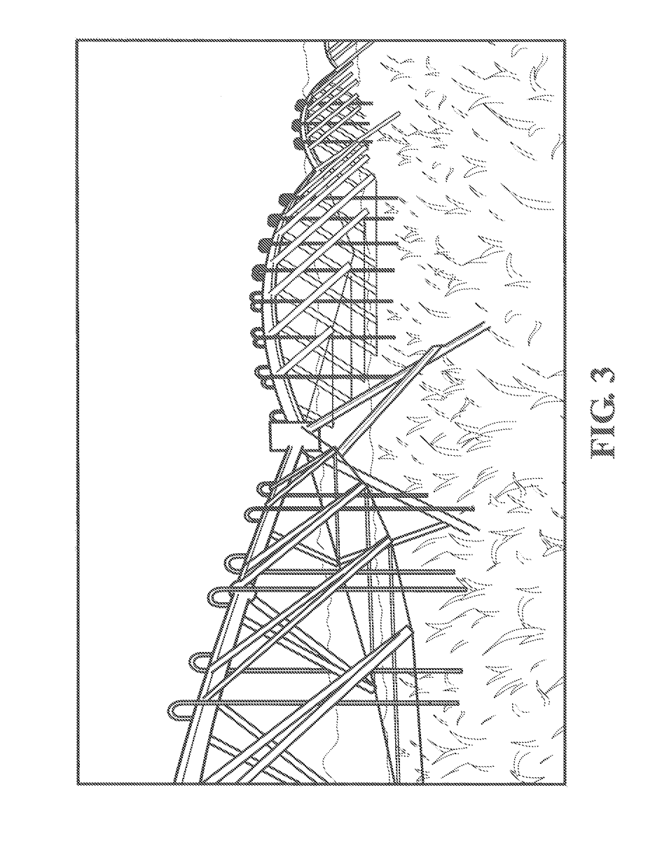

The machine-learning service can communicate with software applications via an Application Program Interface (API). The API provides access to several commonly-used machine adaptation techniques. For example, the API can provide access to interfaces for ranking, clustering, classifying, and prediction techniques. Also, a software application can provide one or more inputs to the machine-learning service. For example, a software application controlling an irrigation head on a pivot, as seen in FIGS. 1 and 3, can provide water usage values as an input to the machine-learning service.

The machine-learning service can include a data aggregation and representation engine (DARE) that constantly receives and stores input data, from multiple field nodes from multiple fields. The stored input data can be aggregated to discover features within the data; such as soil property data such as temperature, pH, moisture level, microorganism colonization, crop residue levels, organic chemical levels, etc.

The machine-learning service in a preferred embodiment, comprises a wireless automation system configured for or using dynamic value reporting which communicates data among and between devices, field nodes 100 and controller 110, related to changes in values of a monitored condition and/or measured parameter (e.g., soil pH). A wireless automation system using dynamic value reporting monitors and wirelessly reports natural resource information over a automation network formed by multiple distributed devices. The distributed devices communicate information between and among the devices from a source device to a destination device.

A device, such as field node 100, that uses dynamic value reporting senses, samples and/or measures a condition during a period of a sampling or polling interval. A reading of the condition may be taken to identify an indicator associated with the current or present condition. The indicator of the current or present condition may be read during a current period of the sampling interval. The current reading of the indicator may be stored with prior readings of the indicator in a memory, preferably in the cloud. The current readings and prior readings may be stored in memory in order in which the readings were read, such as in a stack manner. The current reading of the indicator also may be compared to prior readings of the indicator to determine a change.

The indicator and/or the change may be compared to a limit or range, such as an absolute limit and/or a range for changes from one or more previous measured values. The device wirelessly receives and transmits information over the network. The information may include a current indicator of the condition, a value or status for the condition and/or sensor, and/or the comparison of the indicator to a limit or range, the time or interval sequence number in which an indicator was made, the time or interval sequence in which an indicator is deemed to have changed beyond a limit or outside a range and like information. The information is routed as packets, such as according to a TCP/IP transmission protocol. The information is communicated to a destination device, such as an actuator, and/or a controller that executes a process control such as executing a responsive action, and/or communicating an appropriate control signal. The device may communicate information during a period of a transmission interval.

The field node may communicate information during a transmission, or communication, interval. The information may be communicated in response to a comparison that identifies a change in the sensed condition, such as a change outside a band limit; or a reading of the indicator beyond a limit. Similarly, a transmission of information may be suspended for periods of a transmission interval for which no change in the indicator has been identified. The field node 100 may enter a sleep mode, or go into a standby mode, between periods of the transmission and/or polling interval. The transmission and polling intervals, the limits and ranges may be changed, varied, regulated, adjusted, extended and/or compressed according to the measured values and/or comparison to the limits.

The automation system provides process control functionality for one or more fields. The automation system includes one or more field nodes 100 positioned, or distributed, throughout the field. The field nodes generate and/or receive information related to a specific event, condition, status, acknowledgement, control, combinations thereof and the like. The devices may also respond to control commands and/or execute an instruction received by or in a signal. The devices may also communicate or route the information between and among components of the system from a source to a destination.

The field nodes and controller of the system communicate information, data and commands according to an assigned binding association. That is, devices may be commissioned as an operating pair or group according to a binding association. For example, the field node 100 that provides the reading and the controller 110 to which it is operatively coupled may be bound or assigned to a particular segment of a central pivot boom arm that is scheduled to irrigate the portion of the field for which the field node 100 and controller 110 are resident.

Even though devices (field nodes 100 and controller 110) may be commissioned as an operating pair or group, communications between devices may be routed, or hopped, via one or more other devices of the network. That is, the communication of information between and among devices includes transmitting, routing, and/or information hopping using low-power wireless RF communications across a network defined by the devices. Multiple paths from a source to a destination may exist in the network. A device may communicate to a user through a blue tooth connection; and a user may communicate to any device on the network.

A field node 100 comprising sensors monitors a condition and/or status of an event. The field node 100 may report appropriate sensor information, such as a current value or indicator of the condition, timing of a reading, prior measurements, status of the sensor and/or a comparison of a measured value to a desired limit, range or previous measurement. Field node 100 has the capacity to measure resistive type or voltage type readings through the same input connections as well as digital pulse readings through separate input connections. Field node 100 may also accept optional cord to measure GPS coordinates and accelerometer readings. Actuators may process sensor information to determine an appropriate action for the actuator. Controllers 110 monitor the process or action of sensors and actuators, and may override the sensor and/or actuators to alter processing based on a regional or larger area control process.

Preferably, the automation system includes a supervisory control system, one or more field sensors, and one or more controllers. Each controller, for example, corresponds to an associated localized, field subsystem that measures ambient environmental, soil and crop properties, and is configured to also include hazard detection, security, combinations thereof, or the like. The hazard and or security features are designed to prevent theft and/or pivot damage by either operating too close to sensors or under unfavorable weather conditions that are sensed by the sensors. The controllers communicate with one or more field nodes 100 using two-way wireless communication protocol or hard wire connections. The controllers also may communicate information with one or more actuators using two-way wireless communication protocol. The controllers also may communicate to the memory of the machine-learning service in the cloud. For example, field nodes 100 and actuator are commissioned to communicate data and/or instructions with the controller. The controller provides control functionality of each, one, or both of the sensor(s) and the actuator. The controller controls a subsystem based on sensed conditions and desired set point conditions, which can vary over time based on learned attributes. The controller controls the operation of one or more actuators in response to an event reported by a field node 100. The controller may drive the one or more actuator to a desired set point. For sake of clarity, the actuator can be any type of device, whether hardware or software used to initiate, maintain or terminate natural resource distribution activity required by the soil or crop of interest.

The controller is programmed with the set points and a code setting forth instructions that are executed by the controller for controlling the actuators to drive the sensed condition to be set. For example, the actuator is operatively connected to an irrigation pivot and the field node, which may comprise, among other things, a soil moisture sensor that reports information related to moisture being monitored by the sensor. The field node 100 may report current moisture or a relative moisture change compared to a prior measurement. Additionally, this moisture information can be compared to a reference moisture to water demand curve that is specific to a certain crop type. If the moisture sensed by the sensor exceeds a threshold, the actuator may respond accordingly. The sensor may communicate the sensed condition to the actuator \and/or to the controller, which thereafter provides an appropriate control signal to the actuator. Sensor, actuator, and set point information may be shared among or common to, controllers, field nodes, pivots, and any other components or elements that may affect control of the natural resource automation system. To facilitate sharing of information, groups of subsystems such as those coupled to controllers are organized into wireless field level networks (“WFLN's”) and generally interface at least one field node 100.

The WFLN data networks are low-level data networks that may use any suitable proprietary or open protocol. The devices forming a WFLN communicate via two-way radio links. Interfaces, routers and bridges are provided for implementing the WFLN. The WFLN may include multiple or different communication links between components with some or no redundancy in any of various patterns.

Any of a wide variety of WFLN architectures may be used. For example, the devices of the WFLN may utilize a wireless MESH technology to form a MESH network. For example, the WFLN configured as a wireless MESH network include multiple nodes that communicate via wireless communication links. The MESH network establishes a grid of nodes that create redundant paths for information flow between and among the nodes. In the MESH network, information may reach a destination either by a direct point-to-point communication or by an indirect communication where the information is routed or hops from node to node, among different paths from a source to the destination.

The WFLN may be self-forming and/or self-healing. The WFLN also allows bi-directional routing for command and control information. Additional, different or .ewer networks may be provided. For example, a WFLN may be wired, while other networks may be wireless, one or both wireless networks include wired components, or the networks may be distributed among only one, three or more levels.

In one embodiment, the control system aggregates data gathered from a global network of field nodes 100 and allows users to use such data to increase and predict future crop yield of a designated field. The stored input data may be aggregated to discover features within the data such as soil property data such as temperature, pH, moisture level, microorganism colonization, etc. and to determine the effect of such features on crop yield. A plurality of controllers 110 continually communicate data received by plurality of field nodes 100 to the cloud via an GPRS or Ethernet connection. The cloud comprises an irrigation optimization analytics engine. The analytics engine refines such data submitted by a the network of controllers. The analytics engine categorizes the data by similar crop types, field characteristics and weather conditions. Irrigation outcomes are factored in and efficient irrigation recommendation are made. Local pivot controllers may then draw from the globally aggregated data to “learn” and become more efficient irrigators. Users can use stored data to predict and maximize yield by comparing stored or historical data to current soil data in similar environments.

In one embodiment, the control system further comprises a cloud based portal which allows users to view, override and create reports from a specific field's data. Field data provided may include: irrigation events, current system and site status and system production reports.

The description and illustrations are by way of example only. While the description above makes reference to various embodiments, it should be understood that many changes and modifications can be made without departing from the scope of the disclosure. Many more embodiments and implementations are possible within the scope of this invention and will be apparent to those of ordinary skill in the art. For example, the various embodiments have a wide variety of applications including integrated irrigation control systems, environmental control, security detection, communications, pest control, natural resource distribution, and hazard reporting. The wireless device may be synchronized with other devices. The wireless device may be used with integrated systems where, for, example, an environmental control system may be integrated with a theft detection and prevention system. It is intended that the appended claims cover such changes and modifications that fall within the spirit, scope and equivalents of the invention. The invention is not to be restricted except in light as necessitated by the accompanying claims and their equivalents. Therefore, the invention is not limited to the specific details, representative embodiments, and illustrated examples in this description.

What is claimed is:

1. A control system, comprising:
at least one field node wherein the field node comprises a plurality of sensors configured to detect ambient environmental conditions, wherein the field node further comprises a transceiver in operative communication with the sensors, the transceiver configured to receive the ambient environmental conditions information from the sensors and transmit the information to a controller, the transceiver also configured to receive information from the controller,
wherein the controller is connected to a wide area network and configured to receive information from the transceiver of the at least one field node and transmit the information to the wide area network, the controller also configured to receive information from the wide area network and transmit the information to the transceiver of the at least one field node; and
wherein the controller is configured to operate and control an actuator in response to the ambient environmental conditions information provided by the sensors.

2. The system of claim 1, wherein the plurality of sensors comprise soil moisture sensors and temperature sensors.

3. The system of claim 1, wherein each field node comprises a global positioning receiver configured to receive signals to calculate the location and current time of the field node, wherein the field node is configured to transmit such location information to the transceiver, wherein the transceiver is configured to transmit the location information to the controller.

4. The system of claim 1, wherein each field node comprises gyroscopic features configured to determine the motion of the field node and configured to transmit the motion information to the transceiver, wherein the transceiver transmits the motion information to the controller.

5. The system of claim 1, wherein each field node is configured to log data, report its location and make analytical decisions to self-calibrate, report malfunctions and conserve battery power.

6. The system of claim 1 wherein the controller is configured to include hazard detection and security features.

7. The system of claim 1 wherein the actuator is operatively connected to an irrigation pivot.

8. A wireless automation system, comprising:
a transceiver operable to communicate packets of information over a wireless network;
a sensor operable to generate an indicator for a sensed condition;
a controller configured to poll the sensor at a polling interval to read the indicator during a current period of the polling interval and to selectively operate the transceiver to communicate information associated reading of the indicator;
and a memory, the controller storing a reading of the indicator during the current period in the memory, where the memory stores at least one prior reading io of the indicator, the prior reading of the indicator made during a prior period of the polling interval, wherein the transceiver is configured to transmit a most recent reading of the indicator stored in the memory.

9. A method, comprising:
receiving data related to a plurality of natural resource related features by a machine-learning service;
determining at least one feature in the plurality of features based on the received data using the machine-learning service;
generating an output by the machine-learning service performing a machine-learning operation on the at least one feature of the plurality of features, wherein the machine-learning operation is selected from among: an operation of ranking the at least one feature, an operation of classifying the at least one feature, an operation of predicting the at least one feature, and an operation of clustering the at least one feature, wherein the output comprises a prediction of a volume setting and/or a mute setting of the mobile platform; and
sending the output from the machine-learning service to a resource capable of utilizing that output.

10. A control system comprising an analytics engine configured to receive, categorize and store soil property data received from a plurality of controllers in communication with a plurality of field nodes, wherein such soil property data is linked to known crop yields.

11. The control system of claim 10, wherein the analytics engine is configured to compare the soil property data to known crop yields to determine irrigation and/or fertilization condition metrics that can be used to present to a user based on the soil data and known crop yield comparisons.

12. The control system of claim 11, wherein the analytics engine provides the user with irrigation and/or fertilization recommendations based on relationship of soil data to crop yield comparisons.

13. The control system of claim 11, wherein the analytics engine is operatively coupled with a center pivot and transmits a signal to the center pivot in response to the comparison of soil data with crop yields in order to increase or decrease the amount of irrigation that takes place during a period of time.

14. The control system of claim 10, wherein the analytics engine can also collect and store water availability data and predict crop yields based on the comparison of soil data readings for analogous crop types over a period of time points as compared to historical crop yield data over similar time points for that crop type, when controlled for how much water will be available for irrigation.
